(19) United States
(12) Patent Application Publication
(10) Pub. No.: US 2019/0107661 A1
(43) Pub. Date: Apr. 11, 2019

(54) LIGHT GUIDE WITH LIGHT-DEVIATING STRUCTURES

(71) Applicant: WEIDPLAS GMBH, Küsnacht (CH)

(72) Inventors: Christoph KINDL, St. Ingbert (DE); Norbert QUIEN, St. Ingbert (DE)

(73) Assignee: WEIDPLAS GMBH, Küsnacht (CH)

(21) Appl. No.: 16/090,931

(22) PCT Filed: Apr. 4, 2017
(86) PCT No.: PCT/EP2017/057928

§ 371 Date: Oct. 3, 2018

(30) Foreign Application Priority Data
Apr. 4, 2016 (EP) 16163636.0

(51) Int. Cl. F21V 8/00; B29D 11/00

(52) U.S. Cl. CPC G02B 6/006; B29D 11/00663; G02B 6/0073; G02B 6/0061; G02B 6/0065

(57) ABSTRACT

The invention relates to an optical waveguide (1), which has a plurality of light-deflecting structures (3), which are arranged within the optical waveguide (1). Each light-deflecting structure (3) has an elongated main body (4), which is, dimensioned larger in the longitudinal direction of the main body than in the directions perpendicular to said longitudinal direction by a multiple.

### TECHNICAL FIELD

The present invention relates to a light guide, which has a multiplicity of light-deviating structures. Such light guides are used in various application fields, and particularly in automobile construction, for example in order to produce an illuminable display or decorative element.

### PRIOR ART

Light guides are used to transport light, and are employed in a wide variety of application fields. The light guide guides the light rays emitted by a light source, which are for example introduced into the light guide through a light input face, in its interior to a light extraction face, through which the light rays leave the light guide. The light rays may leave the light guide diffusely in different directions or deliberately in a particular direction, for example in the direction of an observer, in order to achieve a correspondingly desired light effect.

One application field of light guides is found particularly in automobile construction. Thus, it is known in motor vehicles to provide operating and actuation elements located in the interior or exterior space with display and lighting elements, which are illuminated via a light guide from a light source arranged behind, in order to ensure visibility of the individual operating and actuation elements, in particular even at night. In addition, decorative elements and trim strips which are back-lightable, and correspondingly provided with a light guide, are often used in order, for example, in the form of a door sill panel, to indicate the brand name of the motor vehicle, or in order to cause a special effect and in this case to draw the observer's attention to itself. The light guide may therefore, in particular, be used to achieve uniform lighting of the display or decorative element or elements.

Another application field relates, for example, to room lighting and room illumination. Light guides are in this case used in lamps in order to achieve a particular desired emission of the light emitted by one or more light sources. Depending on the application, the desired emission may take place deliberately, and in particular focused, in a particular direction or diffusely in different directions.

In order to guide the light rays as far as possible uniformly and loss-free to a light extraction face, it is proposed in DE 10 2014 216 780 to provide a multiplicity of light-deviating structures in the form of elevations and depressions on the outer face, opposite the light extraction face, of the light guide. However, damage to the surface, provided with the light-deviating structures, of the light guide leads to a modified emission characteristic of the light guide.

DE 299 17 623 discloses a light guide with light-deviating structures, which are arranged inside the light guide. The light-deviating structures are in this case produced by means of laser processing by local melting of the polymer material of the light guide.

### SUMMARY OF THE INVENTION

It is an object of the present invention to provide a light guide which is not sensitive in terms of damage, and which enables efficient and simply adjustable light extraction.

In order to achieve this object, a light guide as specified in claim 1 is provided. Advantageous configurations of the invention are specified in the dependent claims.

The present invention thus provides a light guide having a multiplicity of light-deviating structures, which are arranged inside the light guide. The light-deviating structures respectively have an elongate base body, which is dimensioned along its longitudinal direction by a multiple greater than in the directions perpendicular to this longitudinal direction.

It has been found that light rays which strike one of the light-deviating structures in particular laterally, that is to say from a direction essentially perpendicular to the longitudinal direction of the light-deviating structures, experience a deviation towards the longitudinal direction of the light-deviating structure. Specifically, the light is in this case respectively deviated toward the longitudinal axis of the base body, which extends centrally in the longitudinal direction through the base body.

By the provision of a multiplicity of such light-deviating structures in a light guide, deliberate light deviation of the light radiated into the light guide in one or more particular directions can therefore be achieved. The light may therefore be extracted from the light guide in one or more adjustable directions. Depending on the orientation and position of the light-deviating structures, light extraction may be adjusted in such a way that, for example, it takes place in a focused fashion from the light guide in a particular direction or diffusely in a particular direction range.

The base body of the light-deviating structures is advantageously configured in the shape of a rod. Along its longitudinal direction, the base body is therefore dimensioned by a multiple greater than in all directions perpendicular to this longitudinal direction. Advantageously, it is dimensioned greater by a factor of at least 3, more advantageously at least 5, and even more advantageously at least 10, along its longitudinal direction than in the directions perpendicular thereto at any position along its longitudinal extent. It has been found that the light extraction, in particular the deliberate light extraction, from the light guide becomes more efficient when the base bodies of the light-deviating structures are more elongated.

Since the light-deviating structures are arranged inside the light guide, damage to the light guide surface has little or no effect on the function of the light guide, as regards its light emission characteristic. Advantageously, the light-deviating structures are in this case fully arranged inside the light guide, i.e. completely embedded by the material of the light guide.

Advantageously, the light-deviating structures are produced by a local material modification, in particular by melting of the material, of the light guide. In order to produce the light-deviating structures, the material of the light guide is thus preferably melted at the corresponding positions by means of the effect of heat and cooled down. A local structural modification of the light guide material is thereby caused at the respective positions, so that the light-deviating structures are formed. The material of the light guide is, however, preferably not carbonized during the production of the light-deviating structures.

The material of the light guide is preferably a plastic, glass or an elastomer. Preferably, the light guide is furthermore produced from a transparent material. The plastic may for example be polymethyl methacrylate (PMMA), polycarbonate (PC), polyurethane (PU), polyurea (PUA) or polymethyl methacrylimide (PMMI). The elastomer may, for example, be silicone. Depending on which type of material is used for the light guide, the light-deviating structures produced assume different shapes which may be preferred for particular applications.

The light guide may be a film. The film may, in particular, be produced from PMMA or PC. The thickness of the film is a advantageously 1.8 mm or less, even more advantageously 1.5 mm or less, even more advantageously 1.2 mm or less, even more advantageously 1 mm or less, even more advantageously 0.8 mm or less, even more advantageously 0.75 mm or less, even more advantageously 0.6 mm or less, in particular 0.5 mm, even more advantageously 0.4 mm or less, in particular 0.375 mm, most advantageously 0.3 mm or less, in particular 0.2 mm. Films are generally distinguished by better bendability and flexibility compared with an injection-molded component.

Preferably, a plurality of the light-deviating structures are arranged next to one another in a common plane of the light guide, and in this case advantageously all have the same orientation. Two or more planes may be provided inside the light guide, in which respectively a multiplicity of light-deviating structures are arranged preferably respectively with the same orientation. By means of a light guide with light-deviating structures arranged in two or more planes of the light guide, various light effects can be generated.

Preferably, the light-deviating structures are produced by means of a laser. In this case, the laser light respectively preferably causes local heat input at the corresponding positions in the light guide, which leads to material melting. Production of the light-deviating structures by means of a laser is not only particularly simple, but may also be carried out straightforwardly in such a way as to form the aforementioned elongate base body and the local thickenings and vanes, which will be specified below. During production of the light-deviating structures by means of a laser, it is possible to ensure that, although the material is melted locally, it is not carbonized. Of course, the light-deviating structures may however also be produced by means of any other desired methods known to the person skilled in the art.

The present invention therefore furthermore relates to a method for producing a light guide, which is configured as indicated. In this case, the light guide is irradiated with a laser in order to form a multiplicity of light-deviating structures, each having an elongate base body, inside the light guide.

In order to achieve in optimal shape of the light-deviating structures, they are preferably produced with the aid of green laser light and/or infrared laser light. Preferably, the green laser light has a wavelength in the range of 490 nm-575 nm, in particular about 532 nm.

The infrared laser light advantageously has a wavelength in the range of 780 nm-1400 nm, more advantageously in the range of 1000 nm-1100 nm, in particular about 1030 nm. Infrared lasers are favorable to purchase and are particularly process-stable. An ultrashort pulse laser, preferably a femtosecond laser or a picosecond laser, is advantageously used.

Preferably, the base body of the light-deviating structures is respectively essentially rotationally symmetrical, in particular fully rotationally symmetrical. The light-deviating structures are therefore easier to produce, and the light deviation caused by the light-deviating structures is easier to precalculate. In particular, luminance simulation software may be created in order to precalculate the luminance on the surface, and in particular on the light extraction face of the light guide, or conversely in order to determine the arrangement and/or configuration of the light-deviating structures inside the light guide starting from a desired surface luminance. In this way, any desired luminance distribution on the light guide surface can be achieved very simply. The longitudinal axis of the respective light-deviating structure, which coincides with the symmetry axis, is determined by the rotational symmetry of the base body.

The term “luminance” is intended to mean the ratio of luminous intensity to the size of the visible illuminating light extraction face, which is specified in candelas per square meter of the light extraction face (cd/m²).

In one particularly preferred embodiment, at least one base body has a local thickening along its longitudinal direction, and preferably all the base bodies respectively have a local thickening along their longitudinal direction. The local thickening is preferably respectively arranged off-center in the base body along the longitudinal direction of the base body, that is to say not exactly in the middle of the base body. It has been found that a significant majority of the light rays laterally striking the light-deviating structure are deviated in the direction of the longitudinal axis of the base body.

The thickening preferably has a circular cross section perpendicularly to the longitudinal axis of the base body. Preferably, the thickening in relation to the longitudinal direction of the base body is arranged at 15-35% of the total longitudinal extent of the base body. The diameter of the thickening, measured in a direction which is perpendicular to the longitudinal axis of the base body, is preferably not more than 30 μm.

Advantageously, the base bodies of the light-deviating structures extend essentially parallel to one another, preferably fully parallel to one another, along their respective longitudinal direction. In this way, for example, it is possible to achieve the effect that the light radiated into the light guide is extracted to a significant majority from two mutually opposite, preferably planar, outer faces of the light guide.

In one preferred embodiment, at least one light-deviating structure has at least one, in particular two or more than two, vanes, which are attached to the base body, and preferably all the light-deviating structures have respectively at least one, in particular two or more than two, vanes, which are attached to the base body. Advantageously, the one or more vanes are oriented in the same way in all the light-deviating structures. This offers the advantage that the light is emitted particularly homogeneously by the light guide. The expression vane refers to the shape of the light-deviating structures, and is to be understood as a flap-shaped part attached to the base structure. The vane or vanes preferably have overall an approximately quadrilateral shape, and predominantly extend along two dimensions in a surface, which may in particular be planar. In the third dimension perpendicular to this surface, the at least one vane generally has a thickness which is dimensioned by a multiple smaller compared with the side lengths of the vane in the surface along the first two dimensions. Preferably, the at least one vane is at most 5 μm thick. Preferably, the at least one vane is connected to the base body along one of its four sides, in particular along an entire side length.

By provision of the vane or vanes, the area of the light-deviating structure relevant for the light deviation can be substantially increased, so that significantly more light can be deviated per light-deviating structure. The vane(s) are thus used to improve the efficiency of the light deviation.

Advantageously, at least one vane of the at least one vane extends over ⅓ to ⅔ of the entire longitudinal extent of the base body. The at least one vane may in this case be connected, in particular along one of its sides, to the base body over a range of from ⅓ to ⅔ of the total longitudinal extent of the base body. The width of the vane, measured in a direction perpendicular to the longitudinal axis of the base body, is preferably at most 30 μm.

Advantageously, the base body is formed in one part or several parts, preferably in one part. If the base body is formed in several parts, the base body is preferably constructed at least in two parts. If the base body is constructed in at least two parts, the at least two parts of the base body are preferably separated from one another. Preferably, the at least two parts are connected to one another by means of at least one vane. However, the light-deviating structures are advantageously respectively formed as a whole in one part, that is to say they have no parts separated from one another which are not connected to one another by another part of the same light-deviating structure.

Preferably, in order to achieve a particularly large area relevant for the light deviation, respectively at least two vanes are attached to the base body. In order to maximize the surface of the light-deviating structure with a view to the light deviation, the two vanes are advantageously attached to the base body on essentially diametrically mutually opposite sides, and in particular extend away from the base body in mutually opposite radial directions.

In another embodiment, which is preferred for particular applications, the light-deviating structures respectively as a whole have an elongate and essentially rotationally symmetrical, in particular fully rotationally symmetrical shape. In this embodiment, the light-deviating structures therefore in particular have no vanes attached to the base body, but are advantageously formed exclusively by the base body. Such a configuration of the light-deviating structures leads to a homogeneous luminance distribution on the light guide, and therefore to particularly uniform light emission.

The light guide preferably has a light extraction face, through which the light radiated into the light guide from a light source is emitted outward. Preferably, the base bodies of the light-deviating structures are positioned with their longitudinal directions, i.e. longitudinal axes, respectively essentially perpendicularly to this light extraction face.

In order to be able to achieve good lighting, the base bodies of the light-deviating structures preferably respectively have a longitudinal extent of at least 100 μm, even more preferably at least 300 μm. Advantageously, however, the light-deviating structures, or their base bodies, are at most 800 μm long. Light-deviating structures which have a larger longitudinal extent are visible to the human eye, which in most cases is not desired. With respect to visibility to the human eye, a distance of about 30 cm-70 cm from the light extraction face is assumed in each case here and in what follows. The light-deviating structures are invisible when, in the unilluminated state, from such a distance the region of the light guide with the light-deviating structures can scarcely be distinguished by an observer from a region of the light guide which does not have any light-deviating structures. In particular, the individual light-deviating structures can then scarcely be seen.

Advantageously, the light-deviating structures are arranged at regular or irregular distances from one another, preferably at regular distances from one another, in the light guide. The distances between the light-deviating structures are preferably respectively at least 50 μm, more preferably respectively at least 80 μm, in particular at least 100 μm. The greater the distances between the individual light-deviating structures are, the more difficult they are for the eye to identify in the light guide in the unilluminated state of the light guide. At distances of less than 50 μm, the structures are visible regardless of the laser energy used for producing them. However, in order to ensure sufficient light deviation and therefore lighting in the region of the light extraction face, the light-deviating structures should have distances between one another of preferably at most 400 μm, more preferably of at most 200 μm, in particular of at most 150 μm.

Advantageously, the base body of the light-deviating structures of the light guide has a circular cross-sectional area with a midpoint M perpendicularly to its longitudinal direction, particularly in the region of a possibly present thickening of the base body, a maximum diameter d of the circular cross-sectional area of the base body of a respective light-deviating structure being 30 micrometers or less, and the distance A between the midpoints M of the circular cross-sectional area of the base body of the light-deviating structures of the light guide being at least 50 micrometers.

Preferably, the distance A satisfies the following 1^{st} criterion:

The distance A is more than three times the maximum diameter d of a base body of at least one light-deviating structure of the light guide.

Advantageously, as an alternative or in addition to the 1^{st} criterion, the distance A satisfies the following 2^{nd} criterion:

The midpoint of the circular cross-sectional area of the base body of a respective light-deviating structure of the light guide has a distance A from the midpoint of the circular cross-sectional area of the base bodies of all other light-deviating structures of the light guide, the distance A being more than the maximum diameter d of the circular cross-sectional area of the base body of the respective light-deviating structure divided by the value 0.33.

This advantageous embodiment offers the advantage that the light-deviating structures of the light guide are scarcely visible to the eye in the unilluminated state of the light guide.

Particularly advantageously, the base body of the light-deviating structures has a circular cross-sectional area perpendicularly to its longitudinal direction, particularly in the region of a possibly present thickening of the base body, that is to say a cross-sectional area which is bordered by an outer bounding line that at least approximately, in particular essentially, forms a circle. This outer bounding line has, in particular, a maximum diameter d.

The light-deviating structures may be arranged in the light guide in such a way that the light extracted by the light-deviating structures appears as a letter, text, a number and/or a symbol. In order to achieve this effect, the light-deviating structures may be correspondingly arranged in the light guide in the form of a letter, text, a number and/or a symbol.

According to one refinement of the invention, the various light-deviating structures have different geometries, in particular different longitudinal extents, so that the light extracted via the light extraction face of the light guide has a brightness distribution which varies over the light extraction face. In other words, the varying brightness distribution is caused because of the different geometries, in particular longitudinal extents of the base bodies of the light-deviating structures. A different number of vanes and/or different sizes of the vanes and/or of the thickenings may also lead to different brightness values. The light-deviating structures may thus, for example, overall represent a grayscale image and nevertheless be distributed at regular intervals with respect to one another in the entire light guide. The different grayscale values may, in particular, be achieved by means of different energy inputs during the production of the individual light-deviating structures by means of a laser. Different optical effects may, however, also be achieved by arranging the light-deviating structures at different heights inside the light guide, by different inclinations of the light-deviating structures relative to the light extraction face of the light guide, or by regular and/or irregular distances between the light-deviating structures.

The light guide according to the invention may be used in order to produce any desired component, which may have further elements in addition to the light guide. For example, a component may have a cover layer in addition to the light guide. The cover layer may be injection-molded onto the light guide or for example formed as a transparent film, in which case the cover layer may be used as protection of the light guide against external effects.

The cover layer may, in particular, be colored in order to cause colored lighting. As an alternative or in addition, a coating may be applied on the light guide in order to achieve the corresponding effects or other effects. The application of a coating is possible since the light-deviating structures are arranged inside the light guide, and are therefore not damaged by the coating. The production of a component with such a light guide by two-element injection molding is also possible, since the light-deviating structures are not damaged during the injection-molding process because they are arranged inside the light guide. In addition to the light guide, the component may also have a decorative plate provided with openings, which covers the light guide and, because of the arrangement and shape of the openings, may for example lead to letters, numbers or symbols being displayed. The decorative plate may, in particular, be made of metal.

According to one refinement of the invention, the light guide according to the invention is intended for automobile construction. It may be used to produce a back-lightable decorative element, a trim strip and, in particular, to produce a door sill panel.

### BRIEF DESCRIPTION OF THE DRAWINGS

Preferred embodiments of the invention will be described below with the aid of the drawings, which serve merely for explanation and are not to be interpreted as restrictive. In the drawings:

FIG. 1 shows a lateral view and a plurality of cross-sectional views of a schematically represented light-deviating structure with a one-part base body of a light guide according to the invention;

FIG. 2 shows a perspective view obliquely from above of the light-deviating structure of FIG. 1;

FIG. 3 shows a perspective view obliquely from above of three schematically represented light-deviating structures of a light guide according to the invention;

FIG. 4 shows a perspective view of a schematically represented component with a light guide according to the invention and with a laser for producing light-deviating structures in the light guide, and with an LED light source for introducing light into the light guide;

FIG. 5 shows a sectional microscopy view of a real light guide according to the invention, at the level of the thickenings of the light-deviating structures:

FIG. 6 shows a sectional microscopy view, in a plane through the light guide of FIG. 5 which is perpendicular to the sectional view of FIG. 5, through the base bodies of a plurality of light-deviating structures; and

FIG. 7 shows a lateral view of a schematically represented light-deviating structure with a two-part base body of a light guide according to the invention.

### DESCRIPTION OF PREFERRED EMBODIMENTS

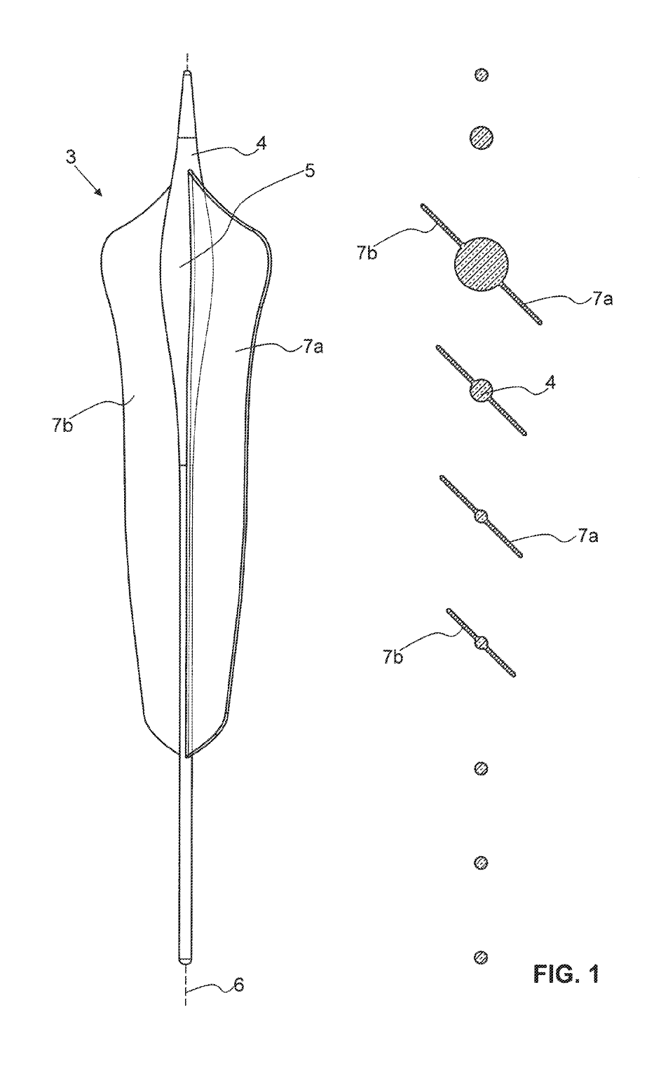

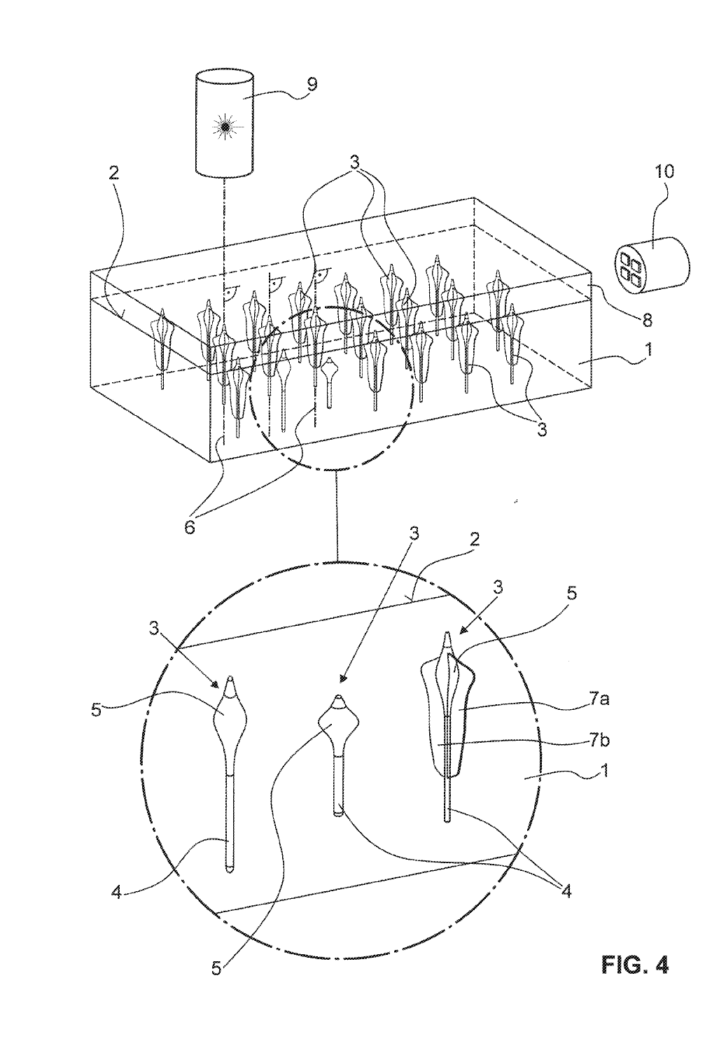

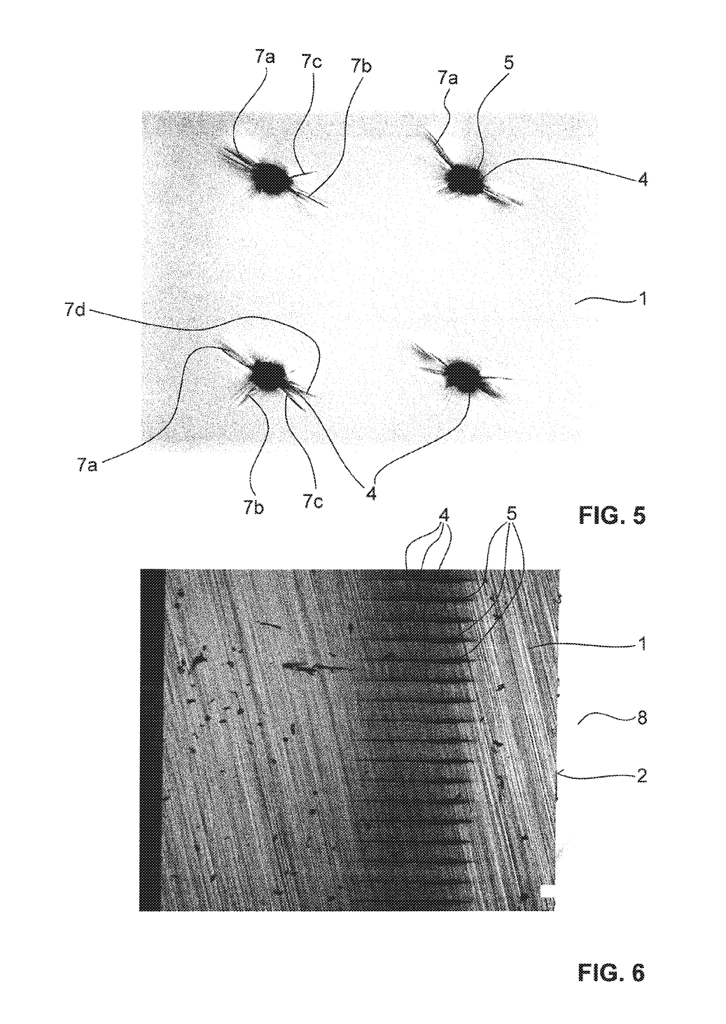

FIGS. 1 to 3 show light-deviating structures 3 of a light guide according to the invention. FIG. 4 shows a component with a light guide 1 according to the invention. Both FIGS. 1 to 3 and FIG. 4 are respectively schematic depictions. FIGS. 5 and 6 show sectional views, produced by microscopy, of a real light guide 1 according to the invention, a multiplicity of light-deviating structures 3 respectively being visible.

In the figures, elements which have the same or a similar function and effect are respectively provided with the same references.

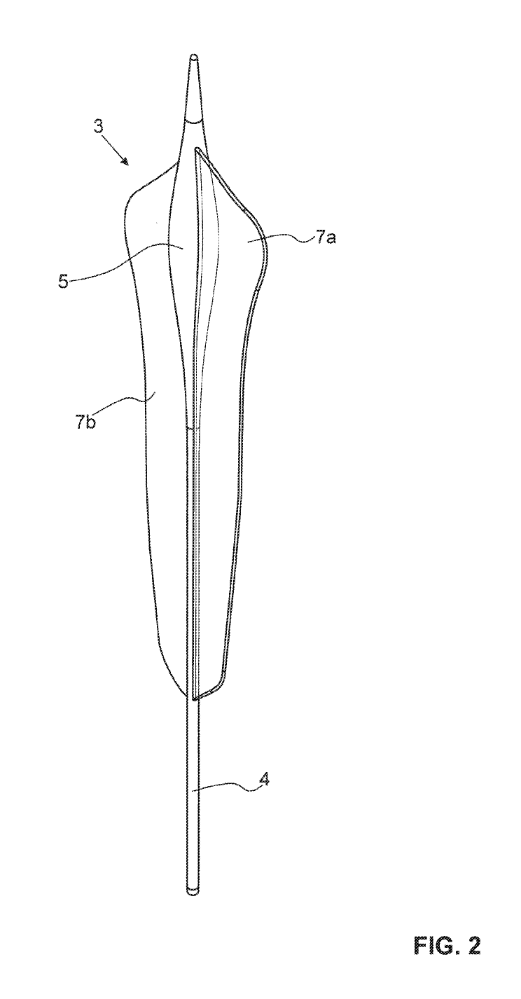

FIGS. 1 and 2 show a single light-deviating structure 3. A lateral view of the light-deviating structure 3 is represented on the left-hand side of FIG. 1, and cross-sectional views in planes perpendicular thereto are shown at the respectively corresponding heights on the right-hand side. In particular, the three-dimensional shape of the light-deviating structure 3 can therefore be seen well in FIG. 1.

The light-deviating structure 3 has a rod-shaped, elongate and one-part base body 4, which is essentially configured rotationally symmetrically and therefore defines a longitudinal axis 6 of the base body 4 and of the light-deviating structure 3, which coincides with the symmetry axis of the base body 4.

Except in the region of a thickening 5, the base body 4 has an essentially constant thickness along its entire longitudinal extent. The thickening 5 is arranged at 15-35% of the total longitudinal extent of the base body 4.

Two vanes 7a and 7b are attached to the base body 4 on diametrically opposite sides. The two vanes 7a and 7b respectively extend to an equal length outward in the radial direction from the base body 4. Each of the vanes 7a and 7b has a flat, essentially quadrilateral shape, and is correspondingly bounded by four outer sides, one of which is connected along its entire length to the base body 4. The upper and lower sides adjacent to this with the base body 4 respectively extend perpendicularly to the longitudinal axis 6 of the base body 4 outward and slightly obliquely toward one another.

The vanes 7a and 7b respectively have the greatest width in their upper region, which is arranged approximately at the height of the thickening 5. Downward, that is to say in the direction away from the thickening 5, the width of the vanes 7a and 7b respectively decreases somewhat.

The thickness of the vanes 7a and 7b, which respectively extend as a whole along a planar surface, is a multiple less than the side lengths of the vanes 7a and 7b. The vanes 7a and 7b respectively have an overall essentially constant thickness.

Along the longitudinal axis 6, the two vanes 7a and 7b are arranged at the same height and extend with their sides connected to the base body 4 over ⅓ to ⅔ of the total longitudinal extent of the base body 4.

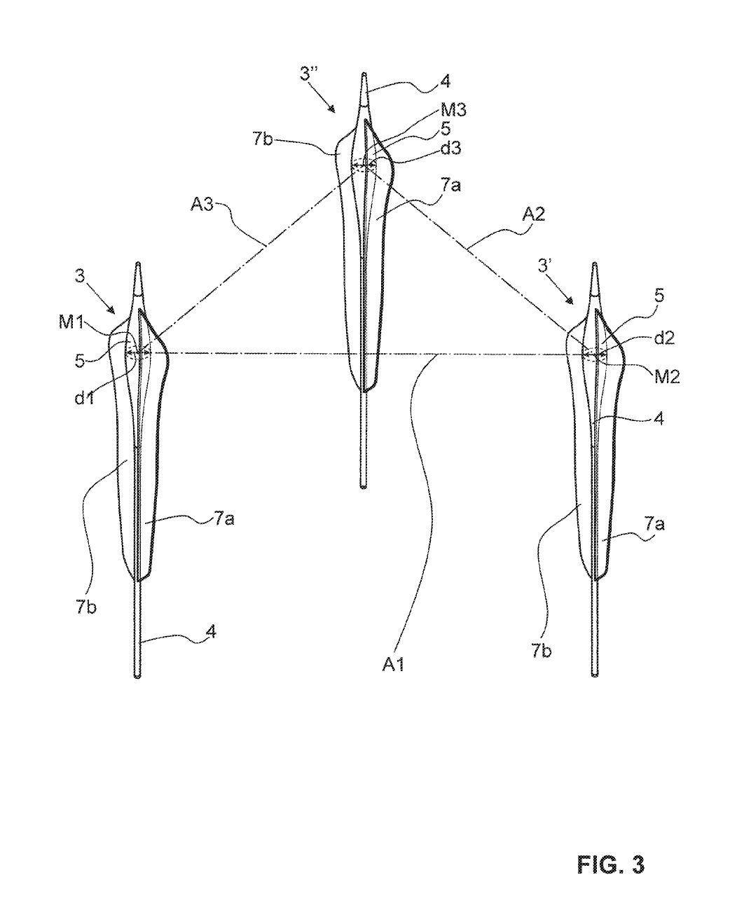

In order to explain a preferred geometrical arrangement, three light-deviating structures 3, 3′, 3″ are represented in FIG. 3, all of which are formed in one part in the present case and which are provided in a light guide according to the invention. The three light-deviating structures 3, 3′, 3″ extend with their longitudinal axes 6 parallel to one another and are arranged at the same height in the light guide.

In the region of the thickening 5, the light-deviating structures 3, 3′, 3″ respectively have a maximum diameter d, or the respective maximum diameters d1, d2, d3, which is preferably at most 30 μm. The maximum diameter d is respectively measured perpendicularly to the longitudinal axis 6. In the regions outside the thickening 5, the diameter of the base body 4 is half as great or even less.

A respective midpoint M1, M2 or M3 of the thickening 5 is respectively defined by the position of the maximum diameter d along the longitudinal extent of the base body 4. In a cross-sectional view perpendicular to the longitudinal axis 6 at the height of the midpoint M1, M2 or M3, the thickening 5 respectively forms a circular surface, which is indicated in FIG. 3 respectively by a dashed line.

It has been found that the light-deviating structures 3, 3′, 3″ are scarcely visible to an observer in the unilluminated state of the light guide when:
the distances A1, A2 and A3 between the respective midpoints M1, M2 and M3 of the light-deviating structures 3, 3′. 3″ are 50 μm or more (i.e. A1≥50 μm, A2≥50 μm and A3≥50 μm), and
the diameters d1, d2, d3 are at most 30 μm (i.e. d1≤30 μm, d2≤30 μm, d3≤30 μm).

Preferably, the distances A1, A2, A3 also satisfy the following 1^{st} criterion: the distances A1, A2 and A3 are respectively greater than three times the diameter of at least one diameter of the diameters d1, d2, d3.

Preferably, in addition or as an alternative to the 1^{st} criterion, the distances A1, A2, A3 also satisfy the following 2^{nd} criterion:

the midpoint of a respective light-deviating structure 3, 3′ or 3″ (for example M1) has a distance A (M1 to M2: distance A1/M1 to M3: distance A3) from the midpoint of all other light-deviating structures of the light guide (M2, M3), the distance A (A1, A3) being greater than the diameter d of the respective light-deviating structure 3, 3′ or 3″ (diameter d1) divided by the value 0.33.

Expressed another way, in the case of three light-deviating structures, or in the case of the three light-deviating structures 3, 3′, 3″, the distances A or the distances A1, A2, A3 are calculated as follows according to the 2^{nd} criterion:
The light-deviating structure 3 is considered as the aforementioned respective light-deviating structure and the light-deviating structures 3′, 3″ are therefore the aforementioned further light-deviating structures. The distances A1 and A3 are therefore respectively at least the diameter d1 of the light-deviating structure 3 divided by 0.33.
The light-deviating structure 3′ is considered as the aforementioned respective light-deviating structure and the light-deviating structures 3, 3″ are therefore the aforementioned further light-deviating structures. The distances A1, A2 are therefore respectively at least the diameter d2 of the light-deviating structure 3′ divided by 0.33.
The light-deviating structure 3″ is considered as the aforementioned respective light-deviating structure and the light-deviating structures 3, 3′ are therefore the aforementioned further light-deviating structures. The distances A2, A3 are therefore respectively at least the diameter d3 of the light-deviating structure 3″ divided by 0.33.

If the maximum diameters of the various light-deviating structures 3, 3′, 3″ are respectively approximately equal in size, i.e. d1=d2=d3=d, the distances A1, A2 and A3 according to the 2^{nd} criterion respectively have to be greater than three times the diameter d (i.e. A1≥3d, A2≥3d and A3≥3d).

The aforementioned indications apply similarly for light guides with substantially more than three light-deviating structures 3, and in particular for light guides in which the individual light-deviating structures 3 are respectively configured and dimensioned in the same way or similarly.

FIG. 4 shows at the top a component with a light guide 1 and a cover layer 8 which is applied on a light extraction face 2 of the light guide 1 and fully covers this face. The cover layer 8 may be injection-molded onto the light guide 1 and produced from a different material than the light guide 1. The component may therefore, in particular, be produced by two-element injection molding, the material of the light guide 1 forming the first element and that of the cover layer 8 forming the second element. The cover layer 8 may, for example, also be a film or a coating, however. The cover layer 8 may form protection of the light guide 1 against external influences. The cover layer 8 may, however, also have a coloration in order to make it possible to emit colored light. Furthermore, it is possible for the cover layer 8 to have the function of a diffuser, in order to cause diffuse light emission and/or reduce the visibility of the light-deviating structures 3. Preferably, the cover layer 8 is configured to be transparent.

In order to produce the multiplicity of light-deviating structures 3 arranged at regular distances and parallel to one another in the light guide 1, all of which are formed in one part in the present case, a laser 9 is used. In this case, laser light is emitted by the laser 9 in order to introduce energy into the interior of the light guide 1 and thereby cause the formation of the light-deviating structures 3 at the desired positions. By the energy input, the light guide material is locally melted and then cooled down. The production of the light-deviating structures 3 may be carried out before the application of the cover layer 8 on the light guide 1 or, as shown in FIG. 4, the laser light may be radiated into the light guide 1 through the cover layer 8. Preferably, the laser light is radiated according to FIG. 4 into the light guide 1 in such a way that the laser light penetrates into the light guide 1 perpendicularly to the light extraction face 2.

For a lighting in the case of intended use of the light guide 1, the light from one or more light sources 10 is preferably radiated laterally into the light guide 1, that is to say in such a way that it strikes the light-deviating structures 3 from a direction approximately perpendicular to the longitudinal axes 6. As an alternative or in addition, one or more light sources may also be embedded in the light guide 1. The light source or sources 10 may, in particular, be LED light sources.

In order to achieve uniform lighting of the light extraction face 2, the light-deviating structures 3 are preferably respectively configured in the same way and preferably arranged at regular distances from one another.

In order to achieve nonuniform lighting of the light extraction face 2 with a varying brightness distribution, the light-deviating structures may be arranged at correspondingly irregular distances from one another in the light guide 1. They may, however, also be arranged at regular distances, i.e. in a regular grid, and instead be configured and/or dimensioned differently in geometrical terms in order to achieve the desired varying brightness distribution. Three differently configured and dimensioned light-deviating structures 3, which in the present case are all formed in one part, are represented by way of example in the detail view of FIG. 4 at the bottom. For example, the light-deviating structures 3 may have different lengths and thicknesses of their thickenings 5, which may be achieved straightforwardly by different energy inputs by means of the laser 9. The light-deviating structures 3 may also be produced in such a way that they have different numbers of vanes 7a, 7b. The light-deviating structures 3 may also be arranged at different heights and/or in different orientations in the light guide 1.

FIGS. 5 and 6 show microscopy images of an actually produced light guide according to the invention. For production of the light-deviating structures 3, all of which are formed in one part in the present case, a green laser from the manufacturing company Coherent GmbH, 64807 Dieburg, Germany, was used. This was the Hyperrapid 25 model, which has a maximum output power of 25 W (watts). The pulse length of the laser pulses was 10 ps (picoseconds) and the wavelength was 532 nm. Focusing was in this case carried out with 100 mm optics, which corresponds to a spot diameter of about 10 μm. The green laser was operated with a power of about 5 W (watts).

As can be seen from FIGS. 5 and 6, it was possible to produce a multiplicity of light-deviating structures 3 in this way. The light-deviating structures 3 shown in FIGS. 5 and 6 respectively have a similar configuration to that of FIGS. 1 to 4. In contrast to the light-deviating structures 3 of FIGS. 1 to 4, the actually produced light-deviating structures 3 of FIGS. 5 and 6 respectively have more than two vanes. In all the light-deviating structures 3, at least three vanes 7a, 7b and 7c and sometimes further vanes can be seen. At least two of the three vanes 7a, 7b and 7c are arranged on essentially diametrically opposite sides of the base body 4, and therefore lead to a particularly large surface crucial for the light deviation.

The thickenings 5 of the base bodies 4 of the light-deviating structures 3 can respectively be seen in FIG. 5. Cross-sectional areas, perpendicular to the longitudinal axes 6, of the thickenings 5 can be seen in particular. In this case, it can be seen clearly that these cross-sectional areas are respectively configured circularly, that is to say they are bordered by an outer boundary line which at least approximately forms a circle.

In tests, it has been found that the total length of the light-deviating structures 3 depends on the laser energy. The same applies for the maximum radius d/2 of the thickening 5. At 15-35% of the total length of the base body 4, the position of the thickening 5 in the longitudinal direction of the base body 4 is however substantially independent of the laser energy.

The material of the light guide 1 shown in FIGS. 5 and 6 is polymethyl methacrylate (PMMA), in particular Plexiglas® 8N from the company Evonik Industries AG (Kirschenallee, 64293 Darmstadt). As an alternative, however, the material of the light guide 1 could also be, for example, Plexiglas® Film 0F058 from the company Evonik Industries.

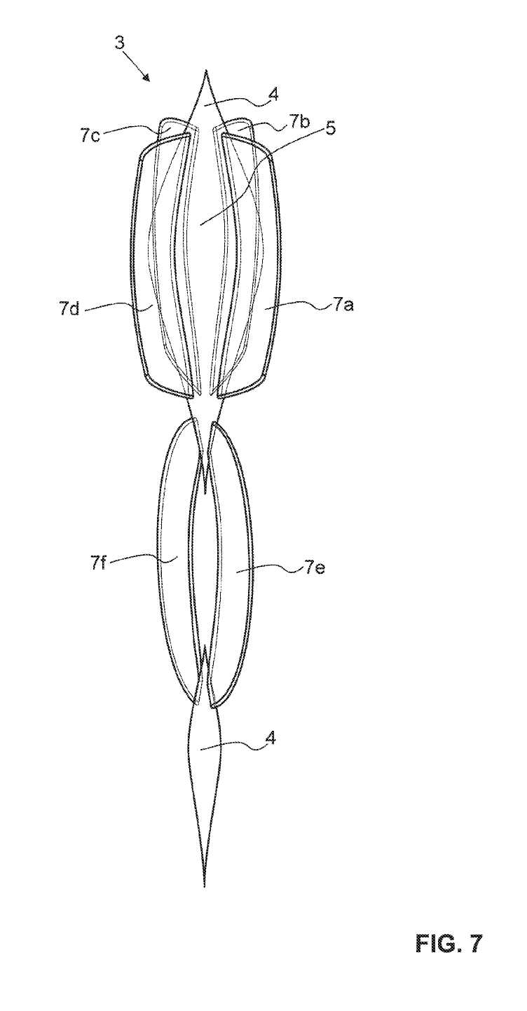

FIG. 7 shows another possible embodiment of a light-deviating structure 3 of a light guide 1 according to the invention. The light guide 1 may have light-deviating structures corresponding to the embodiment shown in FIG. 1 or corresponding to the embodiment shown in FIG. 7. It may of course also have different light-deviating structures 3, i.e. of both embodiments, however.

In contrast to that of FIG. 1, the light-deviating structure 3 shown in FIG. 7 is a two-part base body 4 with two parts arranged at a distance from one another, which are connected to one another by means of two vanes e, f. The light-deviating structure 3 of FIG. 7 has an upper region, in which the first part of the base body 4 is arranged. Four vanes a, b, c, d are attached to this first part of the base body 4, which forms a thickening 5. The four vanes a, b, c, d extent respectively only in the upper region of the light-deviating structure 3. A central region of the light-deviating structure 3 has two vanes e, f, which are respectively connected to one another at their upper and lower ends, but in between extend at a distance from one another. Since no base body part is present in the central region of the light-deviating structure 3, there is an empty space between the two vanes e and f. The light-deviating structure furthermore has a lower region, which is formed by a second part of the base body 4 without vanes fitted thereon. The first and second parts of the base body 4 are therefore arranged at a distance from one another.

In another possible embodiment, the light-deviating structures 3 are formed by means of an infrared laser. To this end, in particular, the laser model TruMicro 2030 from the manufacturer Trumpf GmbH, Johann-Maus-Str. 2, 71254 Ditzingen. Germany, may be used. In one particularly preferred embodiment, this laser model is used with a maximum output power of 25 W, a pulse length of 1 ps, a wavelength of 1030 nm, F100 mm optics, a spot diameter of 20 μm and a pulse energy of 20 μJ, in order to produce the light-deviating structures 3 in the light guide 1. As an alternative, however, the already mentioned model Hyperrapid 25 from Coherent with a pulse length of 10 ps and a wavelength of 1064 nm could for example also be used.

Good results were achieved with an infrared laser, for example with a wavelength of 1030 nm, a pulse length of 1 ps and a pulse energy of 10-15 μJ. For each light-deviating structure 3, there is therefore a power input of 10 MW. With these method parameters, light-deviating structures 3 were produced which have no vanes and therefore cause more uniform light deviation. The light-deviating structures 3 produced respectively had a length of from 150 μm to 300 μm and a maximum diameter of from 3 μm to about 20 μm, the outer shape of the light-deviating structures 3 respectively corresponding to that of the base body 4 shown in FIG. 2. The light guide, within which the light-deviating structures 3 were produced, is for example produced from the material Plexiglas® 8N from the company Evonik.

LIST OF REFERENCES

| | |
|---|---|
| 1 | light guide |
| 2 | light extraction face |
| 3, 3′, 3″ | light-deviating structure |
| 4 | base body |
| 5 | thickening |
| 6 | longitudinal axis |
| 7a-7f | vanes |
| 8 | cover layer |
| 9 | laser |
| 10 | light source |
| d1-d3 | diameter |
| M1-M3 | midpoints |
| A1-A3 | distances |

1. A light guide having a multiplicity of light-deviating structures which are arranged inside the light guide, wherein the light-deviating structures respectively have an elongate base body, which is dimensioned along its longitudinal direction by a multiple greater than in the directions perpendicular to this longitudinal direction.

2. The light guide as claimed in claim 1, wherein the light-deviating structures are produced by a local material modification, in particular by melting of the material, of the light guide.

3. The light guide as claimed in claim 1, wherein the light-deviating structures are produced by means of a laser.

4. The light guide as claimed in claim 3, wherein the light-deviating structures are produced with the aid of green laser light.

5. The light guide as claimed in claim 3, wherein the light-deviating structures are produced with the aid of an infrared laser.

6. The light guide as claimed in claim 1, wherein the base body of the light-deviating structures is respectively essentially rotationally symmetrical.

7. The light guide as claimed in claim 6, wherein the light-deviating structures as a whole are respectively essentially rotationally symmetrical.

8. The light guide as claimed in claim 1, wherein the base bodies respectively have a local thickening along their longitudinal direction.

9. The light guide as claimed in claim 8, wherein the thickening in relation to the longitudinal direction of the base body is arranged at 15-35% of the total longitudinal extent of the base body.

10. The light guide as claimed claim 1, wherein the base bodies of the light-deviating structures extend parallel to one another along their respective longitudinal direction.

11. The light guide as claimed in claim 1, wherein the light-deviating structures respectively have at least one, in particular a plurality of vanes, which is attached to the base body.

12. The light guide as claimed in claim 11, wherein the at least one vane extends over ⅓ to ⅔ of the total longitudinal extent of the base body.

13. The light guide as claimed in claim 11, wherein at least two of the vanes are attached to the base body on essentially diametrically mutually opposite sides.

14. The light guide as claimed in claim 11, wherein the at least one vane as a whole forms an essentially planar surface, which extends outward in a radial direction starting from the base body.

15. The light guide as claimed in claim 1, wherein the light guide has a light extraction face, and wherein the base bodies of the light-deviating structures are positioned with their longitudinal directions respectively essentially perpendicularly to this light extraction face.

16. The light guide as claimed in claim 1, wherein the base bodies of the light-deviating structures respectively have a longitudinal extent of at least 100 μm, preferably of at least 300 μm.

17. The light guide as claimed in claim 1, wherein the light-deviating structures are arranged at distances from one another preferably at regular distances from one another, in the light guide, and wherein the distances between the light-deviating structures are preferably respectively at least 50 μm, in particular 50 μm.

18. The light guide as claimed in claim 1, wherein the light-deviating structures are arranged in the light guide in such a way that the light extracted by the light-deviating structures appears as a letter, a number or a symbol.

19. The light guide as claimed in claim 1, wherein the various light-deviating structures have different geometries, in particular different longitudinal extents, so that the light extracted via a light extraction face of the light guide has a brightness distribution which varies over the light extraction face.

20. The light guide as claimed in claim 1, wherein the material of the light guide is plastic, in particular polymethyl methacrylate (PMMA), polycarbonate (PC), polyurethane (PU), polyurea (PUA) or polymethyl methacrylimide (PMMI).

21. The light guide as claimed in claim 1, which is a film.

22. The light guide as claimed in claim 1, wherein the light guide is intended for automobile construction, and in particular for the production of a door sill panel.

23. A method for producing a light guide, wherein a light guide is irradiated with a laser in order to form a multiplicity of light-deviating structures, each having an elongate base body, inside the light guide.
